(19) United States
(12) Patent Application Publication
(10) Pub. No.: US 2006/0194037 A1
(43) Pub. Date: Aug. 31, 2006

(54) Flexible, breathable polymer film and method for production thereof

(76) Inventors: Dietmar Fink, Berlin (DE); Udo Kueppers, Bremen (DE); Jose Rojas-Chapana, Bonn (DE); Helmut Tributsch, Berlin (DE)

Correspondence Address: LAW OFFICES OF KARL HORMANN, 86 SPARKS STREET, CAMBRIDGE, MA, 02138, US

(21) Appl. No.: 10/542,398

(22) PCT Filed: Jan. 15, 2004
(86) PCT No.: PCT/DE04/00091

§ 371 Date: Jul. 13, 2005

(30) Foreign Application Priority Data
Jan. 15, 2003 (DE) 103 01 984.7

(51) Int. Cl. G11B 5/64

(52) U.S. Cl. 428/323; 427/430.1; 428/141

(57) ABSTRACT

An economical, flexible, breathable polymer film composite modified in at least one of its surfaces by the formation of pores opening out in a funnel shape at the surface thereof, with a nanoscale particle system and which is particularly suitable for packaging purposes. The modification further includes at least one composite layer construction made from a binding agent layer of chemically inert inorganic nanoparticles and a lining layer of hydrophilic non-toxic metal oxide particles which are photocatalytically active under short wave light radiation and which have an anti-bacterial and self-cleaning effect.

### BACKGROUND OF THE INVENTION

1. Field of the Invention

The invention relates to a flexible respiring polymeric film with a spatially ordered structure of capillary pores for making possible an exchange of gas through the polymeric film and to a method of fabricating such films.

2. The Prior Art

Such a polymeric film is a functional porous membrane. Nature has developed many such functional membranes for all developing life. The organic/inorganic composite systems of egg shells are also among these. There structure is built up so that it ensures the vital gas exchange processes (CO₂/O₂ exchange) and the defense against hazards for the developing life (microorganisms) by means of the entire structural arrangement of the egg shell. This efficient biological property serves as a model for the technical development of a functional membrane of the kind to be described. Proceeding from the bio-analogous evaluation of the ultra-structure of an ostrich egg shell as a bionic model system and its suitability for the selection of surface-active agents, a polymeric film is to be developed which by way of pronounces contrast to the egg shall is flexible. This results in a significantly greater field of application and a significantly lower risk of destruction. An ostrich egg is characterized by high stability as a result of optimized composite layers including micro-particles of the CaCO₃ type and spatially ordered structures. As a respiring membrane it displays the capability of efficiently controlling gas exchange processes and acts as an antibacterial protection against the penetration of microorganisms (anti-fouling properties). Moreover, the ostrich egg has properties of high reflection.

A survey of possible applications of such respiring bionic membranes leads foremost to packaging of all kinds. Higher demands for comfort, logistic and environmental protection necessitate qualitatively superior packages. It suffices no longer that packages merely protect a product and make it suitable for transport. In addition, they must be producible in an environmentally friendly manner, suitable for sensible recycling and safe disposing at the end of their useful life. Any material which satisfies all of these ecological and economical requirements must be light, sturdy, breakage proof, transparent as well as of neutral taste, At present, hardly any packaging material is capable of uniting these and additional. Packaging material of the future may set standards provided it is not the “product” packaging material but, rather, the “system” packaging material including its environmentally economic marginal conditions which is optimized as a whole. This is as true for packaged easily perishable and of short-lived food stuffs and plants as the largest field of application as it is for “packages” of consumer goods for daily life, investment goods, and many others. The following may be mentioned as further fields of application for such respiring bionic membranes: Packages in the medical and pharmaceutical area, biologically compatible, antibacterial and respiring films as covers in the areas of construction and design, flexible covers, films integrated in sensor for the control of gas transport, active membranes with autodiagnostic systems, intelligent encapsulations of molecular or nano-scale size as depository for active agents, flexible elements or covers for use in automotive and transportation technology, active covers (cell covers) as functional components of new generations of robots, active covers (membranes) in the area of environmental technology, active covers in filter technology, hazard protection, mouth filters and garment and textile technology.

In respect of the new type of material to be conceived its antibacterial effect (sterilization) and self-cleaning function are important in addition to its respiring function. Photocatalysis is a relatively new known process for combining these two functions. In it, a material which can be excited by light, usually a semiconductor, is exposed by long-wave UV light. This leads to the generation of reactive OH radicals which can destroy microorganisms and neutralize dirt or decomposition gases or liquids. The photo activity is also considered as the cause of hydrophilic properties. It has been possible to demonstrate on the basis of surface tension measurements of small liquid drops that UV light reduced the angle of incidence. This proved a photocatalytic decomposition of organic substances on the coated film surface. The advantages of this process may be seen in the reusability of the catalyst and that the required UV radiation for the chemical reaction may be taken from artificial light as well as from sun light. By modifying the photocatalytically active material (doped or micro heterogenous material) to a sensitivity sensible to longer waves, blue light may be used for the irradiation. Overall, short-wave light irradiation in a range of wavelengths from 300 nm to 600 nm is suitable for generating the described photocatalytic action.

From the prior art it is generally known to impregnate membranes with inhibitors, antibiotics or salts, for instance respiring film for extending the freshness of food or bacteria-repelling packages for food. With such membranes it is not possible to warrant, however, that they also provide for a controlled gas exchange. U.S. Pat. No. 6,114,024 discloses monolithic respiring polymeric films as rigid homogeneous fluid barriers which do, however, permit gas transport by adsorption, absorption, diffusion or desorption. The polymers used are highly hygroscopic so that they tend to absorb water. In their saturated state they permit opposite oxygen and other gases preferable permeation of water vapor into an unsaturated environment. U.S. Pat. No. 6,187,696 B1 discloses a laminate with a fibrous substrate onto which a film is laminated which is pervious to vapor but which block liquids. Yet the laminate is preferably free of micropores. For humidity controlled packaging of food U.S. Pat. No. 6,228,480 B1 discloses a flexible structure coated with a photocatalytic material in which a resin layer is provided between the substrate and the photocatalytic layer to improve bonding and to protect the substrate and the catalytic activity of the photocatalytic material. In particular, it is known from this U.S. patent that titanium dioxide as an n-conductive semiconductor material is a good photocatalytic material with disinfecting and anti-microbiological properties and which under UV irradiation is capable of activating different chemical reactions and in particular of decomposing ethylene gas as a grocery fermentation gas. It is also known that high catalytic activity can be achieved if the titanium dioxide is present as a powder or suspension. The activity may be further heightened by the substrate being porous on its surface in order to increase the contact surfaces of the substrate with the reactants. However, the U.S. Patent does not teach any permeation of the flexible substrate with a photocalytically active material for improving its catalytic activity.

That is, however, the subject of a publication by J. C. Hulteen and C. R. Martin: “Template Synthesis of Nanoparticles in Nanoporous Membranes” (from the book by J. H. Feudler “Nanoparticles and Nanostructured Films” Chapter 10, pp. 235-262, 1998) from which Chapters 10.3.4 “sol-Gel Deposition” (p. 242) and 10.8.2 “Photocatalysis” (pp. 258-259) may be excerpted. It also discloses the application of titanium dioxide for using its photocatalyic sterilizing activities, which is, however, sufficiently commonly known. Moreover, the titanium dioxide is embedded in a porous structure (“template”). The known template is, however, a rigid Al₂O₃ ceramic membrane into the pores of which the titanium dioxide is embedded. Such ceramic membranes are very fragile, however, and are thus unsuited as packaging materials. The titanium dioxide is filled into the pores by a sol-gel method and is then fired at high temperatures and converted into a ceramic. After firing, the complete filling of the pores results in small massive fibrils of hard ceramic (typical several 10 μm in length and about 1 μm in diameter). Thereafter the Al₂O₃ membrane is dissolved and glued to an epoxy resin on the ceramic fibrils. Thus, the only function of this known arrangement is its photocatalytic activity. The difference to solid titanium dioxide is to be seen in the substantially larger surface of the many ceramic fibrils which affects a heightened reaction speed. This known arrangement cannot, however, ensure a controlled gas exchange in a film-like structure.

### OBJECT OF THE INVENTION

It is an object of the present invention, based upon the last-mentioned publication as the closed prior art and upon the ostrich egg as model furnished by nature, to provide a porous material which optimally converts photocatalysis and a production method based upon the sol-gel process, which ensures the control and neutralization of microorganisms while at the same time maintaining an assured exchange of gas. Moreover, the polymeric film is to be impervious to water, be useful in many applications and economically producible in terms of materials used and method steps employed.

### SUMMARY OF THE INVENTION

In accordance with the invention the object is accomplished by a structure as follows: A flexible respiring polymeric film with a spatially ordered structure of capillary pores of selectable diameter and funnel-shaped expansions in at least one surface of the polymeric film making possible an exchange of gas through the polymeric film and with a composite layer structure of at least one transparent binder layer protecting the polymeric film and consisting of chemically inert inorganic nanoparticles and at least one lining film photocatalytically active when irradiated by short-wave light made of hydrophilic non-toxic antibacterial and clean singly active metal oxide nanoparticles applied at least in the area of the funnel-shaped expansions of the capillary pores. Advantageous embodiments of the inventive polymeric film may be gleaned from the subclaims. A preferred method of producing such a polymeric film and embodiments thereof may be gleaned from the corresponding method claims. In terms of their contents relating to the invention all claims will be explained in greater detail in the following general and specific part of the specification.

It is possible with the present invention, proceeding from the bio-analogous evaluation of the ultra-structure of an ostrich egg and its suitability for selecting surface-active reagents, to provide by modification a flexible polymeric film functioning in the manner of a functional ceramic porous membrane by a nano-scale particle system. A technically useful packaging film with physico-chemical properties is being produced which is respiringly active and which protects any potential respiring packaged article from bacterial attack and thus against premature aging and early spoiling. Packaged “living” food, for instance fruit, can be kept fresh longer by the inventive bionic membrane package and protected from drying and loss of flavor. The modified polymeric film can be recycled and disposed without any problems. In accordance with the invention, porous polymeric films whose funnel-shaped expansions of a diameter of but a few micrometers have previously been produced by high-energy heavy ion irradiation, for instance, of large film rolls and by subsequent etching (one-sided etching to provide funnel-shaped expansions in one surface only—single cone—, etching on both sides to provide funnel-shaped expansions in both surfaces—double cone—, are for this purpose subjected to a nano-technologically executed functional structuring of the special funnel-shaped diverging expansions in the nature of a special lining. In contrast to an ostrich egg the lining is not carried our in a large-surface hard form but rather as minute particles in the range of nanometers (5 nm-10 nm) within as well as without the volume of the pores in a substantially homogeneous distribution and which do not interfere with the flexibility of the polymeric film. In this connection, a laminar structure in which a lining layer with the required properties has been applied to a binder layer for improving the adhesion and for protecting the substrate film has been found to be particularly advantageous. A sufficient homogeneity of the pores and a chemical stability of the final product are two of several quality-related properties. Thus, the invention, by a sterilizing and respiring film, provides a bionic packaging material as an environmentally friendly and cost-efficient alternative packaging material. In this context, the polymeric film in accordance with the invention, in a bio-analogous structure, represents an artificial egg shell membrane with a functional nanoparticle liner and has the structural appearance of a photocatalytic respiring smooth and uniformly shining packaging prototype of substantially any desired configuration.

A criterion for realizing the required properties in terms of quality is the interaction at the interfaces between the substrate, binder layer and lining layer or lining nonoparticles. Knowledge of the interfacial phenomena and internal structure of the ostrich egg shell make possible a purposeful selection of components with the goal of optimizing the bionic prototype to be developed (porous membrane structured as a film) dependent upon the size of the particles and the specific surface characteristics of the porous membrane. Analogous to an egg shell, in the polymeric film in accordance with the invention, pores produced in a well-defined manner with an anti-bacterial and self-cleansing lining (hereafter sometimes referred to as “functional lining”) ensure, as a respiring function, an effective gas exchange through the porous film and, at the same time, an anti-bacterial action of its inorganic surface. In this manner it is possible, without additives, significantly to extend the useful life of food packaged in the film in accordance with the invention. By way of significant difference to an egg shell, the polymeric film in accordance with the invention with its membrane function is flexible and, hence, robust and useful in many different ways. The functional lining is provided by a photocatalytically active material. This is a hydrophilic, non-toxic metal oxide in nanoparticles which when irradiated by short-wave light, usually UV light irradiation, is photocatalytically active. Usually ceramic materials, e.g. zinc oxide or trivalent iron oxide, satisfy these requirements. In this connection, titanium dioxide is known best known and, being non-toxic, is permitted in the food industry. Its photo-activity is assumed to be the cause of the required hydrophilic properties. The photo-activity is a semiconductor effect which as regards titanium dioxide occurs at anatas crystals; but rutile and other forms of crystal as well as hybrid forms thereof also display photo-activity. The band gap of the anatas modification of Eg=3.2 eV and the high oxidation potential of the valence band of VVB=3.1 eV (pH0) make it possible to oxidize almost any molecule under UV irradiation (wavelength <390 nm). Titanium dioxide is chemically extremely stable and is soluble in very strong acids only. In bases, however, it is solvent stable. Catalysts and support materials made of titanium dioxide in their specific applications thus do not release any disturbing ions. They are ideally suited as support substances in conventional pH ranges, especially, however, for use in strongly alkaline media (see publication “Leicht zu reinigende und selbstreinigende glatte Oberflächen” [Easily cleanable and self-cleansing smooth surfaces] by A. Biedermann, downloadable in the Internet at http://home.t-online.de/home/titam/rein.htm., Status 9 Dec. 2002).

A brief survey of the economic perspectives of the polymeric film in accordance with the invention is intended to emphasize their importance. In the year 2000, about 1.8 million (metric) tons of packaging films were produced in Germany from polymeric materials. According to estimates by experts in all of Europe comparable products of biologically degradable materials lie at just about 10,000 (metric) tons. High technical requirements must be satisfied, depending upon their application, in connection with the technical packaging materials. Among others, they must be tear proof, flexible, impervious to odors, they must not in any way connect to the packaged goods—usually food—, and last but not least, the economic value of any extension of the useful life of a packaged grocery item as a result of specific properties of packaging films is very high. However, so far it has not been possible, for polymeric packaging films as well as for biologically degradable packaging films,—with a view to their specific applications, e.g. packaging of flowers or fresh breathing food, such as apples—to produce, with the economic intent of extending the useful life of packaged articles, a packaging film structure which is water impervious and at the same time respiring in respect of O₂, CO₂ and water vapor. Such a technical film possesses functional analogous properties of the kind aimed at by the bio-analogous model and realized, for the first time, by the present invention. It is possible, with the developed packaging technology initially to perforate technical polymeric films without any problems and to coat them with ceramic nanoparticles to impart to them respiring and different functional properties (anti-bacterial, self-cleansing, water impervious, etc.). The extended preservation of freshness of food, the longer protection against drying out and the loss of flavor are important economic goals to be satisfied by a functionally optimized bionic packaging film modeled after an ostrich egg. In terms of packaging chemistry the following happens with fresh packaged food: the ripening products such as fruits, vegetables and flowers give off ethylene gas, i.e. a gaseous plant product, which stimulates further ripening. For long-term storage of ripening products it is important as effectively as possible to remove the formation of ethylene gas from the packaging space. The photocatalytically acting particle material contained in the polymeric film in accordance with the invention decomposes the ethylene so that the food can be transported and stored longer without added inhibitors.

Further modifications of the polymer film which result in their improvement as an active packaging material for articles and spaces, also serve to preserve the flavor and extend the useful life of perishable goods which may be packaged into the coated polymeric film in accordance with the invention. For example, among the modifications are sensors, e.g. button-shaped oxygen sensors, integrated in the polymer film for measuring developing gases relevant to the ripening process. The detected measurement values may then qualitatively displayed by way of integrated indicators. These may be fields of possible color changes. Furthermore, micro-encapsulated oxygen storage depositories may be integrated in the polymeric film. These may be nanoparticles which release oxygen. The storage depositories serve as freshness maintaining reservoirs in case of the membrane structure of the polymeric film is inoperative so that it is possible to achieve a significant extension of the freshness period. Last but not least, actuators cooperating by way of control circuits with existing sensors and storage depositories may be integrated in the polymeric film. Usually, such actuators would be valves, for instance, nanoparticles capable of swelling, which in case of need would close the pores. They could, however, also be tubes capable of expanding and shrinking and embedded in the polymeric film and which receive chemical actuation signals.

By the described modification of a flexible well-defined porous polymeric film in accordance with the invention which may be undertaken at one or at both surfaces a way has been found to a functional membrane for many uses. Modification of both surfaces results in a polymeric film both surfaces of which may be used, and its use does not require any orientation of the film with respect to the modified surface. The production may be carried out in respect of one or both surfaces by the sequence set forth in the method claim. The application of chemically inert nanoparticles takes place in a composite layer or hybrid structure with controlled coating rates by a one-sided or double-sided sol-gel process. Where water-based particle soles are used for forming a layer, the particles will condense (gel) since the concentration of the particles will rise strongly as the water evaporates. During drying transparent films are formed with a substantially homogeneous particle distribution the flexibility of which increases as the thickness decreases. Alternatively, colloidal particle solutions may be applied to the polymeric film which make use of stabilizing and highly concentrated particle dispersions for homogeneously coating the films. Further details regarding the claimed production method of the invention and preferred embodiments thereof may be gleaned from the specific portion of the specification.

Embodiments of the invention, especially with respect to the useful materials and layer structures will hereafter be described in the specific portion of the specification on the basis of individual embodiments. For further explanation reference will be had to REM images of layer structures of different parameters on polymeric films in the figures, the depiction and meaning of which will be described in direct connection therewith.

### DESCRIPTION OF THE SEVERAL DRAWINGS

The novel features which are considered to be characteristic of the invention are set forth with particularity in the appended claims. The invention itself, however, in respect of its structure, construction and lay-out as well as its manufacturing techniques, together with other advantages and objects thereof, will be best understood from the following description of preferred embodiments when read in connection with the appended drawings, in which:

FIGS. 1-10 are scanning electron micrographs depicting salient aspects of the polymeric film in accordance with the invention.

### DETAILED DESCRIPTION OF THE PREFERRED EMBODIMENTS

Production of the Porous Polymeric Films with Ion Irradiation.

There are variegated practical applications of generally known filter films with capillary pores. Often, they are manufactured by irradiating impervious films with fission fragments and by subsequent alkaline etching converting the traces of the fragment paths within the material to capillary openings. Instead of fission fragments heavy ions from an accelerator can also be used. For the production of suitable films use is made at applicant's institute (Hahn-Meitner-lnstitut HMI) that in various polymeric materials plasma membranes (Plasmaschlaeuche)—even though only in small quantities—are formed. If an ion permeates a polymeric film at high energy, a plasma membrane is formed for a very short period along the path of the ion. Chemical bonds of the high-molecular substances are fractured, free chemical bonds result, cross-links and new molecules can form in the polymer. These processes are extremely variegated and complex. After permeation of the ion the plasma membrane collapses and an area of changed chemical structure remains which is called nuclear track.

These nuclear tracks may be rendered visible by etching the polymeric materials since the etching rates in the area of the nuclear track is usually higher by several orders of magnitude than in non-irradiated material (about 103 for Kr ions). In polymeric materials such as polyethyleneterephthalate (PET) or polyimide (PI) the irradiated areas are therefore severed from the film. Capillary pores (traces) are formed, the diameter of which (several hundred nm up to 2 μm) is determined by the duration of the etching process and the number of which is determined by the number of projectile ions during the irradiation. By varying the ratio of the trace etching rate to the polymer etching rate (selection of the kind of heavy ions/selection of the etching process) funnel-shaped traces with varying opening angles can be formed. Etching may be carried out on one surface (one-sided funnels) or on both surfaces for producing pores with a funnel at each end of the pores (double cone). The deposit of the particles at highest concentration then takes place in the funnel area since in curved surfaces the potential energy is lowered by the occurring surface difference. Thus, where the photocatalytic action of the nanoparticles is essentially required, i.e. at the entrance of the pores, the best photocatalytic action can be attained by the highly concentrated accumulation. Moreover, the funnel shape has been been found to be advantageous also because it also makes possible a far-reaching access of the short-wave light into the interior of the capillary, thus ensuring the sterilizing and self-cleansing action of the lining layer. In the case of transparent polymeric films with funnel expansions at both surfaces (double cone) the short-wave light also penetrates through the film and thus falls into the area of both funnels so that a great catalytic activity of the lining film is attained. Where, on the other hand, a reflective silver layer is vapor deposited on one surface of the polymeric film, only funnels at this surface will be irradiated. The light is reflected and does penetrate through the film. In that case, a polymeric film modified at one side only can be used. Care must be taken regarding its orientation of use which is not necessary in respect of films modified on both sides.

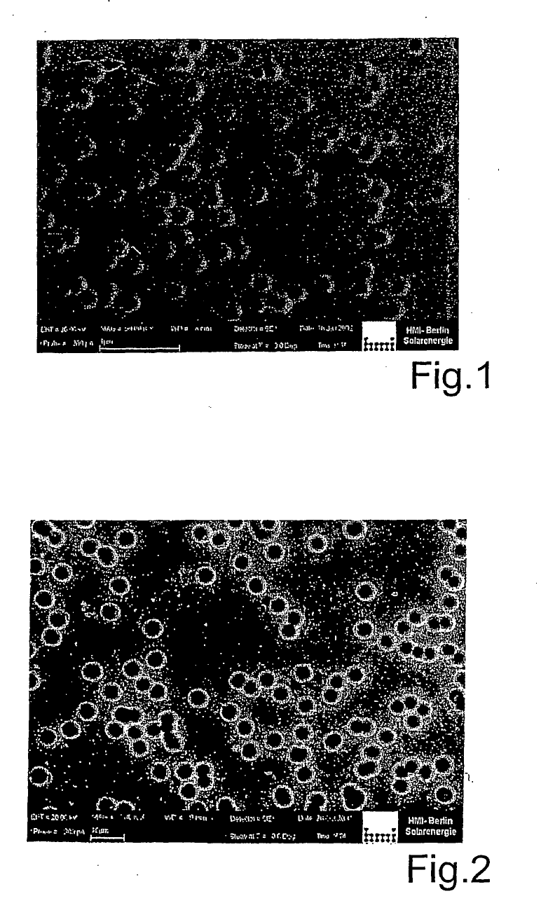

In connection with the porous structure, FIG. 1 depicts a scanning electron micrograph of the surface of an irradiated and subsequently etched polyethyleneteraphthalate film showing funnel-shaped micropores. The polymeric film has about 30 million pores per cm². The diameter of the pores is about 500 nm.

For irradiating the film, fission products from reactors or ions from heavy ion accelerators can be used, with irradiation at the accelerator offering several advantages: It avoids the inherent activation of the film by the fission products at the reactor; the high intensity of the accelerator beams leads to high pore densities; defined pore sizes can be attained by the defined impinging, the same size and energy of the ions; and the higher ion energy allow thicker films to be used. For this purpose, a 300 MeV³⁶Ar¹⁴⁺ beam at 3×10⁷ cm⁻² as well as a 250 MeV⁷⁸Kr¹²⁺ beam at 1×10⁶ cm⁻² were shot through a metallic mask against three different polymeric films (see infra) consisting of polyethyleneterephthalate (PET), polyimide (PI) and grain starch. Thereafter, the polymeric films were etched. The etching agents used were those which for a long time have proven themselves for the etching of ion traces, i.e. for PET and grain starch 5 mol/l NaOH at 450° C. and for Pi a concentrated NaOCl solution at 50° C. at pH values from 8 to 10. Etching of the polymeric film with NaOH or NaOCl is absolutely necessary for the formation of pores, with bonds at the surface being fractured. It is known that the OH attack fractures the (—O—) groups which bond the monomers and that it substitutes (OH) terminal groups for them.

Selected Analytic Processes.

The scanning electron microscope examinations were conducted at HMI. Scanning electron microscope examinations make possible a qualitative and, under defined conditions, quantitative detection of the surface of porous films of certain species. The available electron microscope is a raster electron microscope (Oxford 440) of a conventional three-lens construction with acceleration voltages up to 40 kV and a maximum specimen dimension of 250 mm, a maximum theoretical resolution of 200,000 times and a maximum realistic resolution, depending upon the specimen, up to in excess of 50,000 times. The scanning electron microscope examinations of the surface modifications at the interaction of the solid effective phase (porous polymeric film) with the inorganic binder components (nanoparticles) furnishes information about bonding and morphology of the layers on the surface of the films. For the scanning electron microscope examinations the film specimens to be examined are raster-scanned by a sharply focused electron beam of a diameter of but a few nm. The number of the secondary electrons released in the surface area and of the reflected beam electrons is influenced by the geometry of the surface and results in the surface topography. The grey value of each pixel correlates with the number of the electrons generated at the given scanning point. At a vertical irradiation, inclined surfaces will appear brighter than horizontal ones. Surface steps appear bright. Pores and fissures appear dark. Examination sites with primarily light elements appear darker than those with heavier elements. Example: In a TiO₂/SiO₂ coating the TiO₂ phase appears darker than the SiO₂ phase.

Selected Polymer Systems

In general, it may be said that almost all known polymer systems are suited as support films in the context of the invention. Among these are inorganic polymeric films, for instance, silicone rubber or polysilicon, and organic polymeric films, for instance polyethyleneterephthalate (PET), polyethylene (PE), polyimide (PI), polycarbonate (PC) or polyamide (PA). Mixed composite materials or composite materials of block or copolymers may also be used. Furthermore, films made from renewable resources, such as grain and potato starch, may be realized which are of importance as biodegradable packaging materials. A material will be called biodegradable if all its components are subject to decomposition by biological activity. Films in which a renewable resource has been added as a filler to a conventional polymeric material (PE or PP), cannot be labeled biodegradable in the sense mentioned previously. Biologically degradable for packaging will, because of their relatively favorable price, be produced primarily from natural starch (among these corn starch, potato starch). Other biologically degradable films contain cellulose, sugar or lactic acid. At present, biologically degradable are, however, for to five time more expensive than PE films and therefore of not much interest for a cost-efficient packaging film.

Polyethylenetheraphthalate (PET) produced from crude oil has been known for a long time among polymers for the basic material was first produced as polyester in the USA in 1941 and has since been used as a high-value synthetic fiber by the textile industry. Modern PET is a refined polyester with improved material properties. As a highly loadable polymer, PET is suited for packages, containers, films, fibers and much more. PET packages are characterized by needing very little raw material. The high strength of PET makes possible the production of thin-walled containers and films. Continuous further developments result in ever lighter PET packages. Since products made from PET satisfy even the most stringent hygienic demands and since their use in the fields of cosmetics and food and, above all, in medicine is widely spread, PET films are suited especially for the present invention.

Polyimides are a high-performance non-meltable, colored (often amber colored) polymers with primarily aromatic molecules of high heat resistance. PI's have excellent high-temperature properties and are of excellent radiation resistance. They are inherently difficult to ignite and, when combusting, generate but little smoke. They creep only insignificantly and their wear resistance is very good. However, PI's are very expensive. The have a medium water absorption capacity, they tend to hydrolyze and they are attacked by bases and concentrated acids. In view of these nevertheless excellent properties PI can be used as an alternative polymeric film in the context of the invention, for high-value goods. The same holds true for polyamide (PA) as a polymeric film.

Selected Composite Layer Structure

The polymeric film in accordance with the invention has been tested in several prototypes. The constructed laminate system was made up of an alternating layer structure of titanium dioxide and silicon dioxide with a total thickness below 500 nm. The layer thickness distribution was defined by examinations with a scanning electron microscope. The silicon dioxide serves as a binder. It serves to bond the photocatalytically active substances to the porous surface and, at the same time, it protects the unmodified polymeric film from any detrimental effect of the active substance.

Selected Nano-Scale Species.

TiO₂ powder (P25, Degussa Co.) was used as photocatalytically active, hydrophilic, non-toxic metal oxide nanoparticles. The titanium dioxide used was of the anatas and rutile crystalline structure or, in the case of P25, a mixture of anatas and rutile, Degussa-Huels AG). For preparing the chemically insert inorganic nanoparticles, a SiO₂ dispersion (Levasil® Bayer Co.) Was selected. SiO₂ Levasil® products are aqueous colloidal solutions of amorphous silicon dioxide particles of excellent stability relative to sedimentation. The silicon dioxide is present as uncrosslinked spherical individual particles. A significant characteristic of Levasil® type product is their irreversible conversion of the colloidally dissolved silicon dioxide to a water insoluble silicon dioxide. The following Levasil® types are suited for treating films: Levasil® 100/45%, particle size 30 nm, pH 10, concentration 45%; Levasil® 200/30%, particle size 15 nm, ph 9.0, concentration 30%.

Selected Additional Functional Layers.

The advantage of a composite system is that it can be broadened without difficulty by layer cycles or additional layers. For instance, embedded noble metals, for instance gold or silver, act anti-bacterially. They are chemically active and contribute to sterilization. But metals from the iron group are suitable as well, for instance iron, cobalt or nickel, which possess other functional properties. Nickel, for instance, acts algicidally and is active even in the dark without light. Mixtures of elements are also possible. A sol-gel additive of natural dye stuffs may lead to extremely colorfast colorations. It is also possible to build up entire layers or just partial island areas. The additionally embedded substances are present in very low concentrations only. In view of its properties silver may also be applied as a binder layer. For that reason, metallic silver was tested as a precursor substance of the lining layer as an alternative to SiO₂. Chemical precipitation leads to nano-scale silver particles which protect the film substrate untreated by etching from the photocatalytic TiO₂ activity. Chemical precipitation by means of AgNO₃, NaOH, glucose or NH₄OH with attendant particle size reduction provides for uniform nano-scale layers of silver particles. However, the use of such layers leads to loss of transparency of the modified polymeric film and its taking on a metallic sheen. Regardless of whether the formation of a transparent layer with TiO₂ occurs or whether a silver layer is precipitated as a precursor, the porous property of the films, which is essential to the invention, is maintained.

Furthermore, the photocatalytically active, hydrophilic, non-toxic metal oxide nanoparticles themselves can be modified prior to their processing. For this purpose they may be coated at a low concentration with a swelling layer of an additional substance, for instance calcium hydroxy apatite or just calcium apatite. The additional substance serves in particular for attracting and destroying living substances. By contrast, silver only kills; it does not destroy.

Selected Layer Systems.

The substances for the alternating layer structure applied to the polymeric films which has been produced by the sol-gel method, were produced at atmospheric pressure by hydrolysis and condensation of compounds, soluble in the reaction medium, of at least one element of the group of Si, Al, Ti and Zr, optionally in combination with a biocompatible binder amino silane (N-2-aminoethyl)-3-amino-propyltrimethoxysilan) and subsequent heat treatment (60° C., 1 hour). Hereafter, it will always be the Ti/Si combination which is used, for the effects of these compounds are very well known. Yet other compounds may also be used, such as, for example, zinc oxide (known in medicine for infection-inhibiting bandages) or cerium oxide. When coating the films with TiO₂ as a colloidal solution (pH 3.5) a primary substance is participating in the reaction, to wit SiO₂. The TiO₂ sedimentation takes place primarily after the SIO2 is already present on the substrate surface. This process may, therefore, provide an excellent film protection quality against the photocatalytic activity of TiO₂. Silicon dioxide is known to be partial to reaction with alkaline substances to form silicates. For that reason SiO₂ Levasil® dispersions were selected, for they are alkaline stabilized.

By means of tests it was possible to determine the process conditions which enable homogenous and constant porous film coatings. For that reason, the process was standardized for the intended purpose: Al porous films were treated with the ceramic dispersions by a method known as “dip coating” (Step I). The coating takes place at normal pressure and room temperature (22° C.). At a rate of precipitation of 200 nm in one hour, the a coating rate of between 5 nm/min and 10 nm/min was assumed for an individual coating. After a sufficiently long time (1 hour reaction) an equilibrium is established between particle formation and excess SiO₂, with the coating rate being kept sufficiently low to allow the replenishment of SiO₂ can reach the surface by diffusion process and a rotating coating is possible around the pores. During this phase mono-dispersive SiO₂ nanoparticles attach themselves as a continuous 200 nm layer to the surface of the film. The reaction with the SiO₂ dispersion on the films at room temperature was discontinued by thermal treatment (1 hour at 60° C.); sol-gel process) and repeated rinsing with distilled water. A longer duration of the dip-coating-I-method results in the formation of larger particles (aggregates). Such a particle formation is detrimental, however, to the coating because it results in opaque and non-adhering precipitations.

During the next step for the TiO₂ lining coating, the SiO₂-treated polymeric film prototype was moved to the second reaction zone (dip coating II). This reaction is executed completely analogously to SiO₂ (dip coating). When coating with TiO₂ powder which has been dissolved in a stabilizing SiO₂ containing Levasil® solution (Type 200S/30%, pH 3.8; TiO₂ 20 g/100 ml Levasil®), there takes place an electrostatic action as well as an interaction with the already present SiO₂ layer.

The application of cationically charged TiO₂ particles using amino silane was conducted according to known models. It makes it possible covalently to coat, by way of a controlled modification, TiO₂ particles with a swell coat on th basis of an amino silicone such as, for instance, amino silane (N-2-aminoethyl)-3-amino-propyltrimethoxysilane (AHAPS). In this manner it was possible to increase the surface charge (zeta potential) of the resulting particles with a hydrodynamic diameter in the range of 50 nm-100 nm from negative values up to +33 mV at pH 5.4. The basis of this process is the known fact, that silicone and titanium are prone to bond with organic groups so that a whole class of silanes or hybrid titanium dioxide silanes are created in which many compounds display a significant stability. The process is performed over different intermediate steps. The application of the amino silane-modified TiO₂ layer was performed completely analogously to the process of forming a transparent layer with TiO₂.

Selected Sol-Gel Process.

The additional and decisive sol-gel process is particularly dependent upon the furnace temperature and upon the controlled temperature gradient. At 30° C. already significant gelling can be observed. This circumstance is connected to the extreme water and temperature sensitivity of the system TiO₂/SiO₂. If the furnace temperature is lower the dispersion does not condense. If, by contrast, the temperature is high, destruction takes place of the temperature sensitive polymeric films. That is why the sol-gel transition was performed in air and at normal pressure at moderate furnace and substrate temperatures. Beginning at a temperature of 60° C. the films, after treatment, display stable characteristics, whereas films treated above 100° C. suffer from low stability (fissures). A sel-gel process at 60° C. of about 1 hour thus constitutes a suitable method of coating films. Repeated rinsing of all prototypes with distilled water is required after the thermal treatment, until all condensed precipitations have been dissolved. For broadening the composite layer system, the mentioned method steps may be cyclically repeated correspondingly.

Results of the Examinations.

Nano-Scale Porous Layers.

The use of well-adhering nano-scale agents as binders on the active surface of the solid action phase (porous film) stimulates the interaction of the components in the sense of a precipitation according to the sol-gel process. The examinations of the TiO₂/SiO₂ layers discovered a lowering of the surface tension of the porous films as a function of the layer thickness at simultaneously increasing hydrophily. The appearance of a photocatalytic, respiring, smooth and uniformly brilliant surface could be attained.

Levasil® silicon dioxide has a strong tendency to be of a colloidal state and to form gels under heat treatment. The thin SiO₂ layers which are to be applied as protective layers, in practice behave like a continuous mono-dispersive layer. No aggregates can be observed in the SiO₂ coating. This image of the chemical behavior of silicon dioxide in connection with the secondary TiO₂ coating proves that the use of SiO₂ is a binder and protector is a suitable method of coating films. FIG. 2 depicts a scanning electron micrograph for displaying an Ar-irradiated polyimide (PI) film coated with TiO₂/SiO₂ nanoparticle Levasil® (200/30%; ph 9.0; particle size: 10 nm-2-nm). There are about 30 million pores per chm² with a pore diameter of 3 μm. The white rings correspond to thickly coated zones.

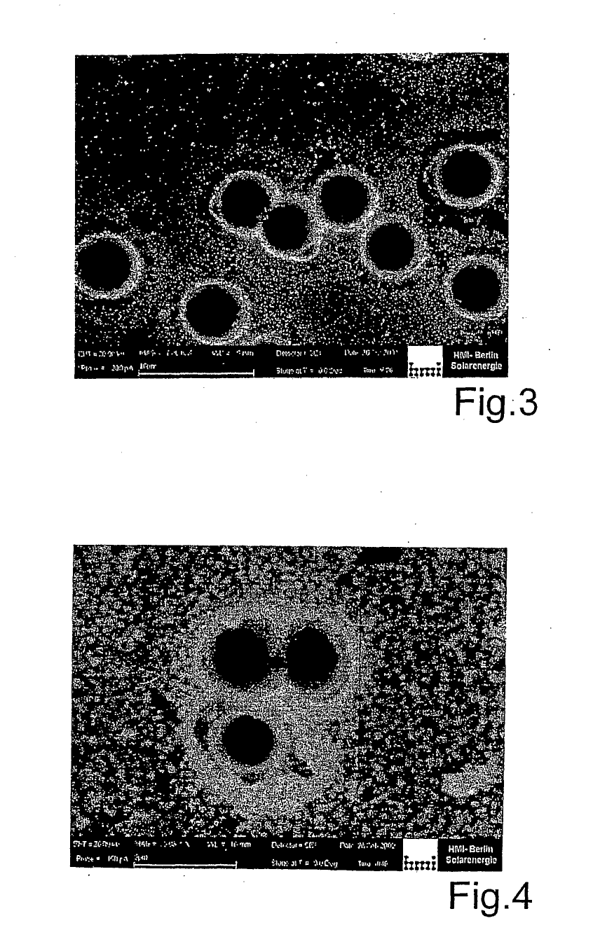

By coating the pre-coated SiO₂ porous films with additive positively charged TiO₂ nanoparticles, a good durability of the photocatalytic coating can be ensured, for incomplete or irregular layers cannot be repaired afterwards. The reason for this may be seen in the fact that beginning at a layer thickness of a few nm in the order of a few dozen of atomic layers, uncoated areas will appear for reasons of the possible distribution of the particle placement. FIG. 3 depicts a scanning electron micrograph of an Ar-irradiated polyimide (PI) film which was pre-coated with a primary SiO₂ nanoparticle Levasil® solution (200/30%; pH 9.0; particle size: 10 nm-20 nm; reaction time 30 min) and after-coated with TiO₂ powder, dissolved in Levasil® (200S/30% SiO₂ colloidal dispersion; pH 3.8; particle size 10-20 nm; reaction time 30 min). The film have about 30 million pores per cm² at a pore diameter of 2.0 μm. Depletion zone may be observed around the thickly coated openings (white rings) on the surface which points to the cooperation between material transition (transport process) and chemical reaction.

A layer thickness of several hundred nm seems to be optimal. FIG. 4 depicts a scanning electron micrograph of a Kr-irradiated polyethyleneterephthalate (PET) film scope pre-coated with a primary SiO₂ nanoparticle Levasil® solution (200/30%; pH 9.0; particle size 10 nm-20 nm; reaction time 60 min) and after-coated with TiO₂ powder dissolved in Levasil® (200S/30%; SiO₂ colloidal dispersion; pH 9.0; particle size 10 nm-20 nm; reaction time 60 min). The films have about 20 million pores per cm² with a pore diameter of 3.0 μm. Thicker layer require a longer reaction time (>>1 hour). As rule layer thickness of about 200 nm were observed. At the openings of the pores typical layer formations, particle distribution and layer thickness could be examined by scanning electron microscopical examinations. A narrowing of the pores by the capillary homogeneous particle arrangement could be seen, which is connected with the entire surface layer thickness of the film. Such examination showed layer thickness of about 200 nm to about 300 nm. A direct measurement of the thickness of the layers can only be taken on specifically produced cross-sections. Such a measurement requires taking into consideration of different side effects and its applicability is strongly dependent upon mechanical properties of the films.

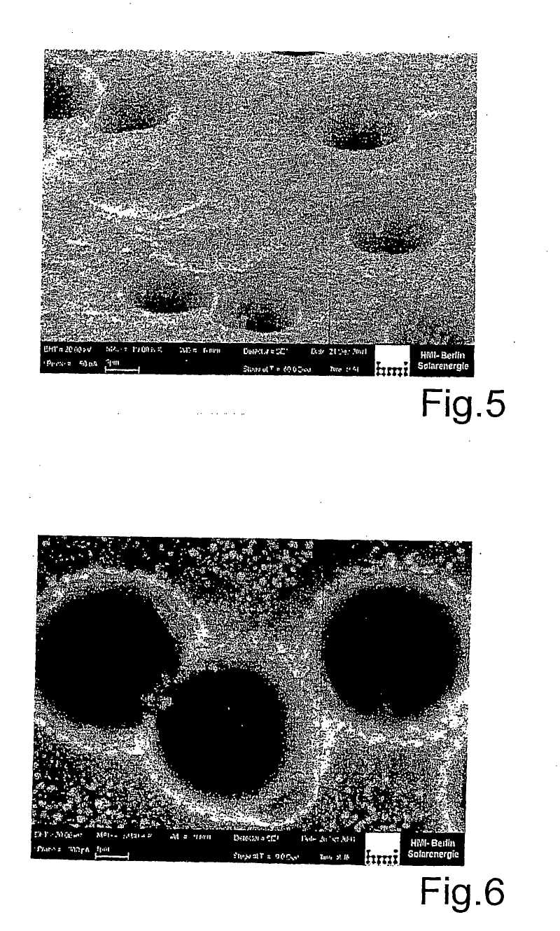

The use of stabilized highly concentrated TiO₂/SiO₂ dispersions facilitates homogenous coating of the films. A depletion of the coating material by the formation of larger particles (aggregate) practically causes the coating to terminate. That is why it is advantageous that a lot of small particles, even though together they form only a small mass, have a very large surface. FIG. 5 depicts a-resolution scanning electron micrograph of an Ar-irradiated polyimide (PI) film coated with a primary SiO₂ nanoparticle Levasil® solution (200/30%; ph 9.0; particle size 10 nm-20 nm) and after-coated with TiO₂ powder dissolved in Levasil® 200/30 SiO₂ colloidal dispersion; pH 3.8; particle size 10 nm-20 nm). The film has about 20 million pores per cm² with a pore diameter of 2.o μm. The porous PI film was covered completely with nanoparticles (TiO₂/SiO₂) by the sol-gel process. With this polymeric film, an optimum TiO₂/SiO₂ layer formation of about 200 nm thickness (coating rate about 5 nm/min) was performed by the sol-gel method (60° C., 60 min, heat treated). A homogenous coating is formed with good optical and scanning electron microscope quality (no fissures, hydrophilic, stable). The internal structure of the pores (capillary walls) was also uniformly coated without formation of any aggregates. It is thus possible with this process the produce stable binder and lining coatings.

Shape and Distribution of the Coated Pores in the Films.

The following examples are shown as visual proof of the porosity of the films after coating. FIG. 6 depicts a high-resolution scanning electron micrograph of an Ar-irradiated polyimide (PI) film pre-coated with a primary SiO₂ nanoparticle Levasil® solution (200/30%; ph 9.0; particle size 10 nm-20 nm) and after-coated with TiO₂ powder dissolved in Levasil® 200/30 SiO₂ colloidal dispersion; pH 3.8; particle size 10 nm-20 nm). The foil has about 20 million pores per cm² with an inner pore diameter of 2.o μm. The micrograph shows 3 pores of about 3 μm diameter in the area of the funnel coated by nanoparticles. The small particles indicate SiO₂ (<<20 nm), the large one, by contrast, indicate TiO₂ (>>30 nm). Thus, the TiO₂ and SiO₂ particles can be clearly recognized within as well as outside of the pore volume. The built-in building block indicate that a capillary reaction is taking place between the inner wall of the pores and the nanoparticles. A connection between the NaOH-etched margins of the pore openings and the number of fixed particles can be clearly recognized. It is these regions in particular which as cylindrical surfaces offer better bonding possibilities for the TiO₂ particles because of their lowered potential than do the smooth surfaces. Because of the particle size the underlying SiO₂ layer can be clearly recognized. At a longer duration of the dip-coating process the films display a complete continuous TiO2 layer in the zones immediately adjacent the pore openings.

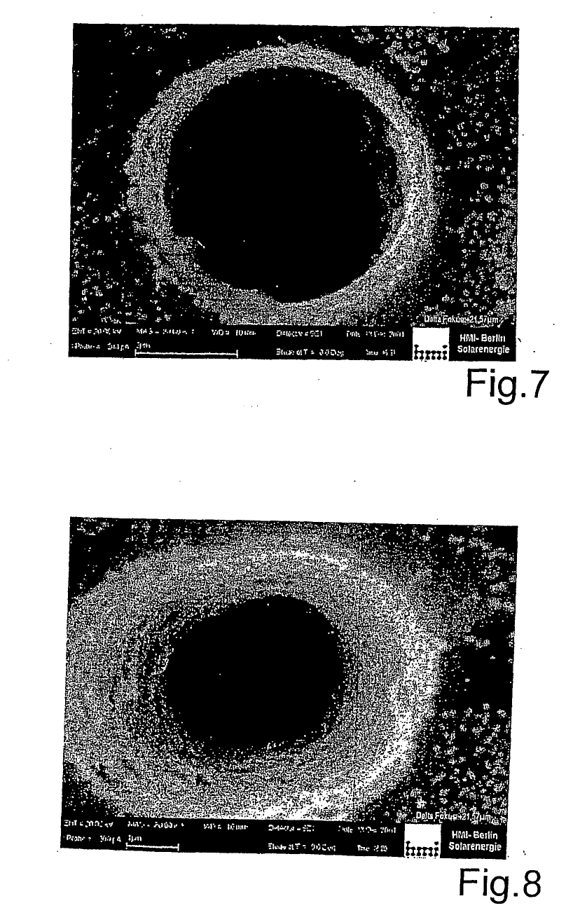

FIG. 7 shows a scanning electron micrograph of a pore opening (about 2 μm diameter) in a Kr-irradiated polyethyleneterephthalate (PET) film pre-coated with a primary SiO₂ nanoparticle Levasil® solution (200/30%; ph 9.0; particle size 10 nm-20 nm; reaction time 60 min) and after-coated with TiO₂ powder dissolved in Levasil® 200/30 SiO₂ colloidal dispersion; pH 3.8; particle size 10 nm-20 nm). The micrograph depicts the opening of a coated capillary tube displaying a strong affinity for nanoparticles. By contrast, the region around the capillary opening is showing a rather poor TiO₂ deposit. By maximizing the depth of field it was possible to look into depth pf 21.6 μm within the capillary. The entire thickness of the film is 30 μm. Hence, the micrograph shows the strong affinity of the nanoparticles to the pores (particle insertion). In this context, different layer formation mechanisms cooperate under the conditions mentioned supra.

Morphology of the Pores.

Usually the etched pores are of cylindrical shape with a funnel-shaped expanded region and the surface of the film. For this reason the light (daylight and artificial light) necessary for the photo-activity of the TiO₂ can penetrate into greater capillary depths. FIG. 8 depicts an enlarged scanning electron micrograph of a Kr-irradiated polyethyleneterephthalate (PET) film pre-coated with a primary SiO₂ nanoparticle Levasil® solution (200/30%; ph 9.0; particle size 10 nm-20 nm) and after-coated with TiO₂ powder dissolved in Levasil® 200/30 SiO₂ colloidal dispersion; pH 3.8; particle size 10 nm-20 nm). The micrograph shows a capillary tube (about 6.5 μm diameter at its outer margin and 2.5 μm diameter in the interior space at a distance of about 21.6 μm from the surface to the narrowest point) of funnel-shaped configuration. This morphology depicts the closed and homogenous particle insertion into the wall of the capillary structure. FIG. 8 thus shows a conical opening of the kind important to the functional action of the claimed polymeric films. It can be recognized that the walls coated with TiO₂ for reasons of their construction alone have a heightened reflective capacity. Because of the difference in refractive indices between the most variegated angles within the walls of the pores the decomposition of harmful organic material can take place here very efficiently. The fact is to be noted that the internal diameter of the funnel-shaped diverging pores becomes so narrow that the structure prevents any contamination by loose bacteria.

Silver Layer on the Polymeric Foils.

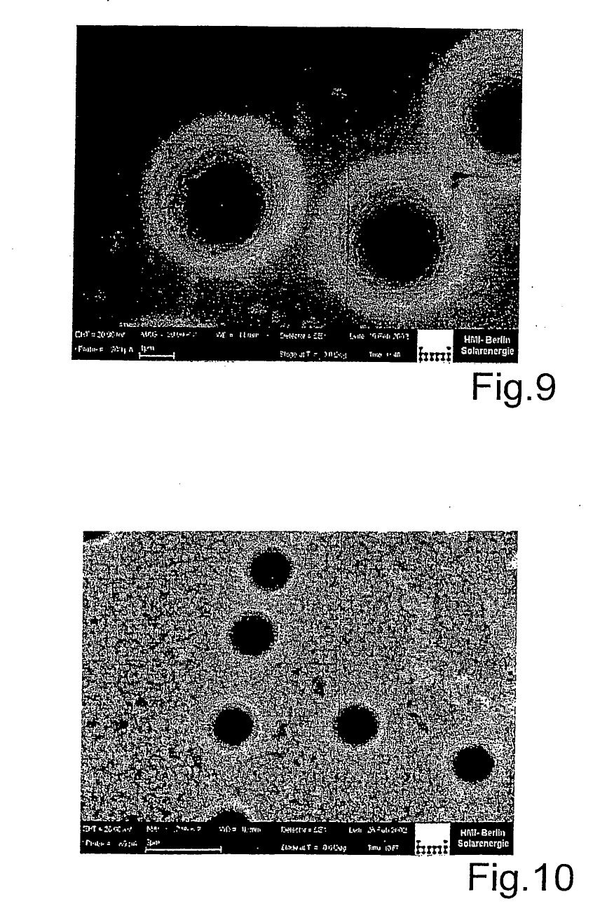

For technical and functional reasons, silver precipitation as a precursor substance of the TiO₂/SiO₂ coating is advantageous. The reason for a silver coating is that the etched ion traces (pores) are protected from the photocatalytic activity of the TiO₂ and that light can better penetrate into the interior of the capillary. This is accomplished by applying on the surface of the porous film a very highly reflective silver mirror obtained after chemical precipitation. Silver nitrate, NaOH, glucose and NH₄OH are used. With silver nitrate it is, indeed, possible to provide a very homogenous and stable coating on PET as well as on PI films. According to scanning electron microscope measurements the Ag coating has a thickness of about 50 nm to 100 nm. Thicker layer require longer process time without improving the protective action: On the contrary, the protective action is reduced because comparably thick layers of up to several μm generate considerable inherent tensions, show fissures and break off. FIG. 9 shows a scanning electron micrograph of an Ar-irradiated porous polyimide film coated with an Ag film of 100 nm thickness. The micrograph shows a continuous homogenous Ag layer on the PI surface of the film. The pores of the film structure have remained intact after the coating (1.0 μm diameter). AG coated films facilitate the fixing of anionically charged particles. During post-treatment of the Ag coated films by additive SiO₂/amino silane modified TiO₂ dispersion it was found that an optimal coating and layer thickness is attained with an Ag layer as precursor of the TiO₂/SiO₂ coating.

FIG. 10 depicts a scanning electron micrograph of a Kr-irradiated polyethyleneterephthalate (PET) film provided with a primary Ag layer as precursor layer and after-coated with TiO₂ powder dissolved in Levasil® solution 200S/30% SiO₂ colloidal dispersion; pH 3.8; particle size 10 nm-20 nm. The use of a well-adhering silver mirror on the PET surface improves the interaction of the ceramic components (TiO₂/SiO₂) by stabilizing the monodispersed particles (50 nm-100 nm) against aggregating particle formation while simultaneously maintaining the porosity of the film. With an Ag coating on porous films, the production is realized of a smooth and uniform anti-bacterial interface between the surface of the film and the environment (TiO₂/SiO₂/water/air). As a result of the large surface of the particles a sufficiently high concentration of anti-bacterially acting silver ions is ensured in the contact area. The presence of colloidal silver in the vicinity of a virus, fungus, bacteria or of another monocellular germ renders its oxygen-metabolism-enzyme, its “chemical lung” inactive. The germ suffocates, dies and is thereafter decomposed by the photocatalytic TiO₂ activity.

Summarizing Observations from Examinations with an Scanning Electron Microscope.

When preparing polymeric films it is possible to produce funnel-shaped tracks as capillary pores with different opening angles by varying the ratio between the rates of track etching and polymer etching.
During processing a colloidal dispersion film (water-containing TiO₂/SiO₂ oxide hydrate film) is present on the surface of the film which is converted into a constant TiO₂/SiO₂layers only after a sol-gel process and thermal treatment. By the so-called sol-gel process it is possible to compose a gelatinous grid (gel) of inorganic or inorganic/organic material from a liquid mixture (sol).
The quality of the porous films is decisively determined by the properties and thickness of the TiO₂/SiO₂ layers. The film coating which can be attained remain transparent provided added particles are of nanometer size.
The thickness and quality of the TiO₂/SiO₂ layers are strongly affected by the film substrates, by minutest surface contaminations, by altering the surface because of temperature and humidity of the air and by the chemistry of different film substrates.
Silicon dioxide layers or TiO₂ layers containing silicon dioxide were used in connection with the present invention as insulating layers to separate the photocatalytic activity of TiO₂ from the polymeric substrate of the films as well as as template (binder) of the TiO₂ layers to apply the TiO₂/SiO₂ uniformly to the films.
The formation of the nano-scale TiO₂/SiO₂ layers on porous films requires the use of a very clean reaction chamber for minutest invisible dust particles in the air or, for instance, finger prints and other contaminations act like a reaction as a repelling nucleation surface (artefact). Such artefacts quickly lead to localized growth of the layer or the termination of the precipitation process.
Ag layers are to act as insulating layers as well as anti-bacterially. Silver particles are to protect the polymeric structure of the films from photocatalysis. The films will then no longer be sensitive to TiO₂; however, the transparency of the films is replaced by a silver surface. On the other hand, on the surface of capillary pores with a funnel-shaped entrance area of optimized opening angle the thin silver layer makes possible a high light intensity even in deeper areas of the film.
Except for the Ag coating and the irradiation of the films, the present invention provides for a cost-efficient method of producing functional polymeric films in view of the fact that the cost of the polymeric film, the layer material, the agents and the cost of the required heat treatment are comparatively low.
It could be shown that polymeric films, for instance PET, which are made exclusively from petrochemical materials can be very well coated with nanoparticles. According to the currently available results, biologically degradable polymeric materials, such as grain starch, reveal different physico-chemical properties which still prevents an optimum pore formation and sol-gel process. Only after the conditions based upon experiments and subsequent quantitative and qualitative analyses here, too, have become such as to make possible a standardized treatment, these novel materials will also become suitable substrates for ceramic nano-scale coatings.

What is claimed is:

1. A flexible respiring polymeric film with a spatially ordered structure of capillary pores of selectable diameter and funnel-shaped expansions in at least one surface for enabling the exchange of gas through the polymeric film and a composite layer structure of at least one transparent binder layer of chemically inert inorganic nanoparticles for protecting the polymeric film and at least one lining film adhering to the binder layer and made from hydrophilic non-toxic metal oxide nano-articles which under short wave light irradiation are photocatalytically active which are anti-bacterially and self-clean singly effective, with their effectiveness being adjustable by the selection of the opening angle of the funnel-shaped expansions of the capillary pores.

2. The flexible respiring polymeric film according to claim 1, with funnel-shaped expansions of the capillary pores in both surfaces of the polymeric film.

3. The flexible respiring polymeric film according to claim 1 with an organic structure, especially of polyethyleneterephthalate (PET), polyimide (PI) or polyamide (PA).

4. The flexible respiring polymeric film according to claim 1 with silicate particles, noble metal particles, especially silver particles or particles of a metal from the iron group, especially nickel particles, or a mixture of particles as chemically inert inorganic nanoparticles for the binder layer.

5. The flexible respiring polymeric film according to claim 1 with ceramic particles, especially titanium dioxide, or with a mixture of particles as photocatalytically active hydrophilic non-toxic metal nanoparticles for the lining layer.

6. The flexible respiring polymeric film according to claim 1 with a mixture of nanoparticles for the binder layer and the lining layer.

7. The flexible respiring polymeric film according to claim 1 with a further species of nanoparticles for satisfying further functions, especially anchoring functions, with the further nanoparticles, especially calcium hydroxy apatite or silver nanoparticles are integrated as additional layer in at least island-shaped structure or as a mixture into the other nanoparticles.

8. The flexible respiring polymeric film according to claim 1 with a non-toxic color additive for coloring the polymeric film.

9. The flexible respiring polymeric film according to claim 1 with a capillary diameter of the capillary pores in the range of 100 nm-2 μm and a size of the nanoparticles in the range of 5 nm-100 nm, with the size of the capillary and nanoparticle diameters being coordinated for maintaining the respiring function, and a thickness of the composite layer structure in the range below 500 nm.

10. The flexible respiring polymeric film according to claim 1 with integrated sensors detecting the chemical and physical parameters of articles and spaces surrounding the polymeric film and with indicators displaying the parameters.

11. The flexible respiring polymeric film according to claim 10 with an integrated micro-encapsulated oxygen storage depository.

12. The flexible respiring polymeric film according to claim 11 with integrated actuators cooperating in control circuits with the present sensors and storage depositories.

13. A method of producing a flexible respiring polymeric film with a spatially ordered structure of capillary pores of selectable diameter and funnel-shaped expansions in at least one surface for enabling the exchange of gas through the polymeric film and a composite layer structure of at least one transparent binder layer of chemically inert inorganic nanoparticles for protecting the polymeric film and at least one lining film adhering to the binder layer and made from hydrophilic non-toxic metal oxide nano-articles which under short wave light irradiation are photocatalytically active which are anti-bacterially and self-clean singly effective, with their effectiveness being adjustable by the selection of the opening angle of the funnel-shaped expansions of the capillary pores, especially in accordance with one of claims 1 to 12, with the cyclically repeatable method step maintainable under clean-room conditions:
Dip-coating step I: surface wetting of at least one surface of the porous polymeric film with a water-based dispersion of chemically inert inorganic nanoparticles in colloidal solution for forming the binder layer at normal pressure under atmospheric air and room temperature;
Sol-gel step I: moderate thermal treatment of the formed binder layer in a temperature range not detrimentally affecting the polymeric film for condensing the solution;
Rinsing step I: repeated rinsing of the hardened binder layer with distilled water for removing unbound nanoparticles;
Dip-coating step II: surface wetting of the surface of the porous polymeric film coated with the binder layer with a water-based dispersion of photocatalytically active hydrophilic non-toxic metal oxide nanoparticles in colloidal solution for forming the lining layer at normal pressure in atmospheric air and room temperature;
Sol-gel step II: moderate thermal treatment of the formed lining layer in a temperature range not detrimentally affecting the polymeric film for condensing the solution;
Rinsing step II: repeated rinsing of the hardened lining layer with distilled water for removing unbound nanoparticles.

14. The method according to claim 13, with a treatment of both surfaces of the polymeric film used.

15. The method according to claim 13 with a solution of the photocatalytically active hydrophilic non-toxic metal oxide nanoparticles in powder form in a colloidal dispersion with the chemically inert inorganic nanoparticles.

16. The method according to claim 13 with a porous polymeric film of polyethyleneterephthalate (PET), polyimide (PI) or polyamide (PA), silicon dioxide powder as chemically inert inorganic nanoparticles and titanium dioxide as photocatalytically active hydrophilic non-toxic metal oxide nanoparticles.

17. The method according to claim 13 with a controlled modification of the photocatalytically active hydrophilic non-toxic metal oxide nanoparticles by sufficiently lasting coating with a swelling layer, especially on the basis of an amino alkyl silane.

18. The method according to claim 13 with method step preceding dip-coating step I or alternative thereto of applying a silver layer to the polymeric film.

19. The method according to claim 18 with method step integrated or preceding the preceding or alternative method step of applying a silver layer on the polymeric film for applying further functional layers or parts thereof of nanoparticles.

20. The method according to claim 19 with a preceding method step for applying a layer with anchoring function with the used nanoparticles consisting preferably of calcium-hydroxy-apatite.

21. The method step according to claim 13 with an integrated non-toxic dye additive for coloring the composite layer structure.

22. The method according to claim 13 with a preparatory method step for forming the capillary pores in the polymeric film by high-energy irradiation with fission fragments or ions for generating chemically modified traces und subsequent non-technological surface treatment by etching of the irradiated polymeric film, with capillary pores with funnel-shaped expansions of differing opening angles being producible by varying the ration of the rates of trace etching and polymer etching.
